(19) United States
(12) Patent Application Publication
(10) Pub. No.: US 2022/0350507 A1
(43) Pub. Date: Nov. 3, 2022

(54) Dynamic Management of Data Storage for Applications Based on Data Classification

(71) Applicant: KYNDRYL, INC., NEW YORK, NY (US)

(72) Inventors: James David Cleaver, Grose Wold (AU); Michael James McGuire, Sydney (AU); Pramod Vadayadiyil Raveendran, Bengaluru (IN); Seema Nagar, Bangalore (IN); Kuntal Dey, Rampurhat (IN); MITCHELL HOLT, Woollahra (AU)

(21) Appl. No.: 17/245,047

(22) Filed: Apr. 30, 2021

(51) Int. Cl. G06F 3/06

(52) U.S. Cl. CPC G06F 3/0631; G06F 3/0647; G06F 3/0605; G06F 3/067

(57) ABSTRACT

A computer-implemented method, computer system, and computer program product for dynamic management of data storage of data associated with a computer application by a computing device based upon data classification of the data. The computing device receives access to data associated with the application. The computing device determines a data classification of the data associated with the application. The computing device allocates storage in a new data platform based upon the data classification of the data.

### FIELD OF THE INVENTION

The present invention is directed towards the field of computer data storage, and more specifically to dynamic management of data storage associated with applications based on a classification of the data associated with a computer application.

### BACKGROUND

The present embodiments relate to dynamic management of computer storage associated with applications executing in a distributed computing environment. As an increasing number of applications move to the cloud, or another distributed computing environment such as across any sort of network, a problem presents itself of where data associated with the distributed computing environment is stored. Sometimes, data associated with the distributed computing environment needs to be stored in a certain fashion, pursuant to functional requirements associated with the data such a need for fast retrieval of the data by the application, compliance requirements associated with the data itself (such as preferred practices by a major corporation), regulatory requirements (such as required by dynamically changing data privacy laws), or various other needs associated with the distributed computing environment.

Historically, an application administrator or developer was tasked with directly managing where data would be stored for the relevant application, and correspondingly need to configure the application to access/store/modify/etc. this data. This is a time-consuming task, and requires hands-on management by application administrators, developers, project managers, etc. If a regulatory requirement applicable to the data changes, for example, it is necessary again for hands-on treatment to dynamically adjust where data is stored, and correspondingly reconfigure the relevant application on how the data is accessed.

### SUMMARY

Embodiments include a method, computer system, and a computer program product for dynamic management of data storage of data for a computer application based upon a data classification of the data, including, if necessary rapid instantiation of data platforms, if necessary. Access to data associated with an application is received. A data classification of the data associated with the application is determined. Computer storage in a new data platform is allocated based upon the data classification of the data associate with the application. The data associated with the application is migrated to computer storage. The application is automatically modified to access, modify, and/or store the data.

These and other features and advantages will become apparent from the following detailed description of the exemplary embodiment(s), taken in conjunction with the accompanying drawings.

### BRIEF DESCRIPTION OF THE DRAWINGS

The drawings referenced herein form a part of the specification. Features shown in the drawings are meant as illustrative of only some embodiments, and not of all embodiments, unless otherwise explicitly indicated.

FIG. 1 depicts a system diagram illustrating a schematic diagram of a system 100 for dynamic management of data storage for applications based upon data classification, according to an embodiment of the invention.

FIG. 2 depicts a flow chart illustrating an embodiment of the invention for dynamic management of data storage for applications based upon data classification.

FIG. 3 depicts a block diagram illustrating components of software application, data source, data orchestration module, and data platform(s) of FIG. 1, in accordance with an embodiment of the invention.

FIG. 4 depicts a cloud-computing environment, in accordance with an embodiment of the present invention

FIG. 5 depicts abstraction model layers, in accordance with an embodiment of the present invention.

### DETAILED DESCRIPTION

In response to this, the inventors propose a new invention to dynamically manage data storage of data associated with a computer application based upon an automatically performed classification of the data. The invention, in various embodiments, dynamically allocates, reallocates, and adjusts storage for data, etc. based upon the classification of data, such as by instantiation of new cloud computing data platforms to hold the data, moving data between existing data platforms, moving data within areas of memory having different levels of protection, etc., and correspondingly automatically modifies the computer application to access and modify this data within the new data platform, based upon changing regulatory/compliance/functional requirements for protection of the data. Within the context of the present invention, this occurs in an automated fashion to avoid a time-consuming, hands-on process by the application administrators, developers, etc. to move data manually, as well as modify software to access and use this data based upon changing requirements for the data itself.

The present invention, in various embodiments, may be useful to the banking industry, healthcare industry, automotive, government, defense, as well as useful to various internet of things devices, all of which must comply with new and changing regulatory/compliance/functional requirements.

It will be readily understood that the components of the present embodiments, as generally described and illustrated in the Figures herein, may be arranged and designed in a wide variety of different configurations. Thus, the following detailed description of present embodiments of the invention is not intended to limit the scope of the embodiments, as claimed, but is merely representative of selected embodiments. It should be understood that the various embodiments may be combined with one another and that any one embodiment may be used to modify another embodiment.

References throughout this specification to “a select embodiment,” “one embodiment,” or “an embodiment” means that a particular feature, structure, or characteristic described in connection with the embodiment is included in at least one embodiment. Thus, appearances of the phrases “a select embodiment,” “in one embodiment,” or “in an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

As shown and described herein, a technical solution to the technical problem of dynamic management of data storage based upon changing regulatory/compliance/functional needs is provided by developing the system, computer program product, method, and other aspects described and/or illustrated herein.

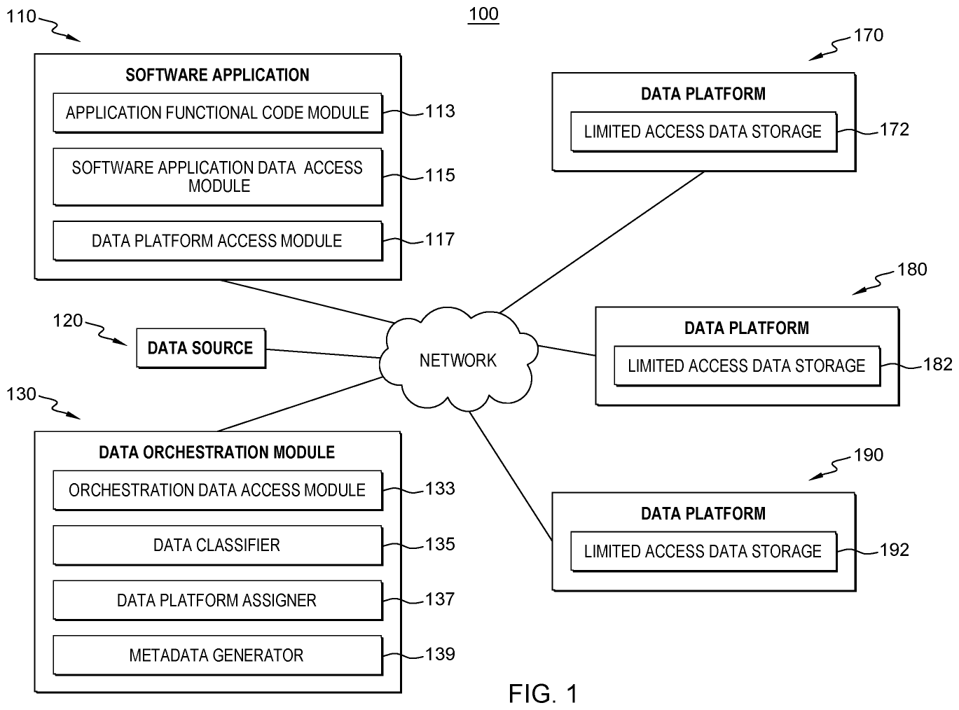

Referring to FIG. 1, a schematic diagram of a system 100 for dynamic management of data storage for applications based upon data classification is depicted. As shown, software application 110 is in functional communication with data source 120, data orchestration module 130, and one or more data platforms 170, 180, 190. Software application 110 during execution of one or more distributed or local software programs, may access/modify/copy/etc. data made available from data source 120. Data from data source 120 may be subject to various regulatory issues, compliance, functional, etc. requirements, all of which are contemplated in the context of the presently disclosed invention. A regulatory authority (such as a country, state, international, or other government entity) may require, for example, that certain data requires special handling, such as by storage in remote servers with limited access rights (complying with various data residency or data privacy requirements), single tenancy vs. multiple tenancy requirements, specific availability requirements, storage on encrypted servers, or even storage on servers that make data available on a preferred basis to software application 110 with a dedicated (and faster) connection. Another regulatory authority may, for example, issue a regulation requiring that banking information is stored for a minimum of 7 years in a protected computing environment (such as a dedicated server). Regulatory authorities internationally may have diverse, changing, and sometimes conflicting needs for storage and maintaining of data based on which nation the data originates from, with the present invention providing for compliance with all of these requirements on a country-to-country basis. A compliance authority, such as a corporation maintaining payment information data may require that payment information data is stored in an encrypted fashion in a separate server (or other enterprise compliance policies). Functionally, data used by software application 110 may need to be stored in a manner allowing for fast retrieval by software application 110, disaster resiliency, and redundancy, scalability requirements, etc. Embodiments of the present invention provide protection for data in all these situations.

Data orchestration module 130, as further described herein, serves in various embodiments, to determine a data classification of the data made available from data source 120 (or, in other embodiments, determines data classification of data made available from software application 110). Classification of the data occurs for the purposes discussed herein. In various embodiments of the invention, when determining the data classification of the data, data orchestration module 130 may interpret metadata associated with the data, directly analyze data made available from data source 120 (such as in a streaming environment), and, after a classification is made, adds other new metadata to the data from data source 120, and/or perform other functionality. The new metadata added to data from data source 120 may include specific information on SLA requirements, replication requirements, encryption requirements, regulatory requirements, etc. If the data orchestration module 130 determines after classification that the data from data source 120 is subject to a regulatory, compliance, functional, or other requirements, in accordance with an embodiment of the invention, the data orchestration module 130 will allocate appropriate storage for the data in one or more data platforms 170, 180, 190 in performance of storage management functionality. The data platform 170, 180, 190 selected by the data orchestration module will have the appropriate pre-requisite security requirements, compliance requirements, functional requirements, etc. for storage, as well as provide for future access by the software application 110. Data orchestration module 130 may move data directly to data platforms 170, 180, 190, or request that data be moved to these platforms. Data orchestration module 130, in various embodiments, also creates data platforms 170, 180, 190 itself which sufficient to meet the various requirements. Data orchestration module 130, in various embodiments, also changes, or requests that changes be made to software application 110, if necessary, to access/modify/store data in question, such as by automatically modifying pointers to data in software application 110, providing access via an application programming interface to the new data location, or an equivalent means. Some of these “changes” may be invisible to a developer of software application 110, since a called object, method, class, etc. may be changed, without any obvious change to source code associated with software application 110.

As shown in FIG. 1, in various embodiments of the invention, software application 110 is a local or distributed computer program executing as computer program instructions on one or more computer processing devices. Software application 110 may be any sort of computer program which relies upon or generates data in performing various services, such as an artificial intelligence application, internet-of-things management software, a cloud application, a word processor, customer relationship management software, enterprise resource planning software, or any other application requiring protected data storage. In one embodiment of the invention, software application 110 directly generates data, storage of which is managed by data orchestration module 130, as further discussed herein. As shown in FIG. 1, application functional code module 113 is responsible in various embodiments of the invention, for storing, executing, modifying, and/or providing access to source code and/or an application programming interface associated with software application 110. If, as discussed in the context of embodiments of the presently disclosed invention, regulatory/compliance/functional changes occur such that data made available to software application 110 needs to be stored in a new data platform 170, 180, 190, upon request from data orchestration module 130, application functional code module 113 serves to modify software application 110 to make such data available, such as by modifying source code (or, in other embodiments, executes changes to data platform 170 to comply with various requirements), changing pointers within application 110 to relevant data, changing relevant variables within source code, etc., as is further discussed herein. Software application data access module 115 is responsible, in embodiments where data originates from data source 120, for providing access to this data. Data platform access module 117 is responsible for providing software application 110 access to the data once it is stored in data platforms 170, 180, 190, especially in situations where data is migrated to data platforms 170, 180, 190, and pointers, links, etc. need to be updated for software application 110 to access data. In an embodiment of the invention, data platform access module 117 resides at a server level, and may execute as a software driver associated with the server. Software application 110 (or, in various embodiments, multiple software applications 110), access data platforms 170 via the software driver.

Data source 120 represents software and/or hardware for any sort of generator, originator, storage device for, provider, etc. of computer data for use with software application 110, and in the context of the presently disclosed invention. Data source 120, in various embodiments of the invention, may be sensors associated with an internet-of-things device, a digital video recorder, a digital audio recorder, a database, a file system associated with a financial institution, or any other source of computer data. Data within data source 120 may be made available in a native format (such as a stream of numeric values from a sensor), as streaming data, an .avi file, a .mov file, a .wav file, a .cst file, a .trm file, an .sql file, etc. or any other presently existing or after-arising means of transmitting computer data, to be made available for processing, execution, storage, etc. with software application 110. As discussed further herein, data from data source 120 is classified for storage in data platforms 170, 180, 190, if necessary, to comply with regulatory/compliance/functional requirements, as determined by data orchestration module 130. In various embodiments of the invention, metadata (associated with the data in question) also comes from data source 120, and is further utilized as discussed herein. In various embodiments of the invention, data source 120 (or some functionality) is integrated with software application 110, and therefore software application 110 is the source of data and metadata.

Data orchestration module 130 represents software and/or hardware for dynamic management of data storage for data from data source 120 (or management of data resulting from elsewhere in system 100, such as generated by software application 110). Data orchestration module 130, in various embodiments of the invention, is responsible for allocating local or remote data storage (such as in a private cloud or private portions of a hybrid cloud computing instance, or other limited access computer storage) to store data for further utilization by software application 110, if a determination is made that the data is subject to regulatory, compliance, functional, or other requirements. In embodiments, data orchestration module 130 works with storage management software (or storage virtualization software) associated with data platform 170, 180, 190, when ensuring that data received is stored correctly (i.e. pursuant to requirements) in data platforms 170, 180, 190, and/or data is moved between data platforms 170, 180, 190, which maintains the necessary pre-requisites. When data is available from data source 120 or software application 110, orchestration data access module 133 of data orchestration module 130, etc., in various embodiments of the invention, receives access to the data. Data classifier 135 of data classification module 110 determines a classification of the data. Data access module 135, in various alternative embodiments of the invention, executes at an application layer, or in an intermediate system between software application level 110 and data platforms 170, or even in more than one location. By non-limiting example, when data classifier 135 determines the classification of the data, data classifier 135 may determine whether the data is financial data, sales data, personal data, banking information, or data of another category which is a regulatory requirement, compliance requirements, and/or a functional requirement. In one embodiment of the invention, data classifier 135 reads existing metadata associated with the data in making the classification. In determining the classification of the data, data classifier 135 may access one or more heuristic rules, use a machine-learning based tool, access a rule based-system (such as one based on an internal corporate policy), directly review data made available and compare it to a template of data types which are subject to enhanced protection, etc. Data may having different regulatory/compliance/functional requirements based upon the context. If data classifier 135 determines that data made available from, in various embodiments, from data source 120 or software application 110 is subject to a regulatory requirement (such as the need to comply with data protection under laws of various states and countries, the need for maintenance of records for a certain timeframe), a compliance requirement (pursuant to, for example, internal policies for a corporation or other entity maintaining the data such as the need to maintain certain data in an encrypted form, or on protected servers), or a functional requirements (such as, by non-limiting example, the need to make data available, modifiable, and updatable on a fast basis by software application 110, a need to provide sufficient backup for data, disaster resiliency, etc.), data platform assigner 137 can rapidly request movement (or move directly), the data in question to one or more data platforms 170, 180, 190, satisfying the pre-requisites for the data. In one embodiment of the invention, metadata generator 139 of data orchestration module 130 also appends new metadata regarding the newly generated classification to the data itself, for further classification and utilization. As is understood by one of skill in the art, metadata appended to the data itself may be used in further classification and storage, in the context of the present invention. Note, also in some embodiments of the invention, one or more functions associated with data orchestration module 130 are integrated with software application 110.

Data platforms 170, 180, 190 represent computer software and/or hardware for dynamic storage of data received from software application 110 and/or data source 120. Although only three data platforms 170, 180, 190 are shown, in various embodiments of the invention each represents multiple such containers. In various embodiments of the invention, data platforms 170 may be private/hybrid cloud computing instances, independent servers, portions of secondary storage, protected memory areas, part of a computer file system, a section of an application, or any other computer storage. Data platforms 170, 180, 190, in various embodiments of the invention, may be direct-attached storage, network-attached storage, one or more storage area networks, object storage, or file storage, all of which comply with various functional/regulatory/compliance requirements, and are located in different places of a hybrid-multicloud setting. In various embodiments of the invention, data platforms 170, 180, 190 maintain a database maintaining a mapping between each application 110 and storage associated with data it accesses, along with information regarding attributes of the storage. In further embodiments of the invention, a controller is responsible for allocation of storage between data platforms 170, 180, and 190, as well as moving data between these platforms as requirements change.

In any embodiment, data platforms 170, 180, 190 serve to limit access to data stored within to certain users and/or applications (such as software application 110), while complying with necessary requirements, such as requiring encryption, a limited access server, password protection, etc. Each data platform 170, 180, 190 may contain block storage, file storage, in-memory storage, archiver storage, object storage, or otherwise, as appropriate to comply with regulatory/compliance/functional requirements associated with the data. By limiting access to data, one or more of data platforms 170, 180, 190 may comply with regulatory requirements such as promulgated by various legal authorities which may require, for example, that data subject to the requirements is only made available to users on a need-to-know basis, on a specifically requested basis, in an encrypted form, etc. As regulatory requirements continue to change, an embodiment of the presently disclosed invention presents the opportunity to dynamically change data access to data in data platforms 170, 180, 190 to comply with changing regulatory requirements, while automatically modifying software application 110 to access this data, without requiring an individual or a team of individuals to change the configuration of the software application 110 on a time-consuming, hands-on basis. Alternatively, as compliance requirements continue to change, such as best practices requested by a corporation or other organization, another embodiment of the presently disclosed invention presents the opportunity to change data access in data platforms 170, 180, 190 to comply with these compliance requirements, again without the need for a hands-on change to software application 110. In situations where functional requirements for data continue to change, such as the need to access certain data on a preferred, faster basis, by software application 110, or a lessened need for certain data by software application 110, in an embodiment of the invention, data platforms 170, 180, 190 provide for data being transferred to non-preferred storage within data platforms 170, 180, 190, while still satisfying dynamically changing functional/compliance/regulatory requirements. As functional/regulatory/compliance requirements change, data may be moved between platforms 170, 180, 190 to comply with new requirements, such as by moving one or more storage containers from one physical device to another to meet the new requirements.

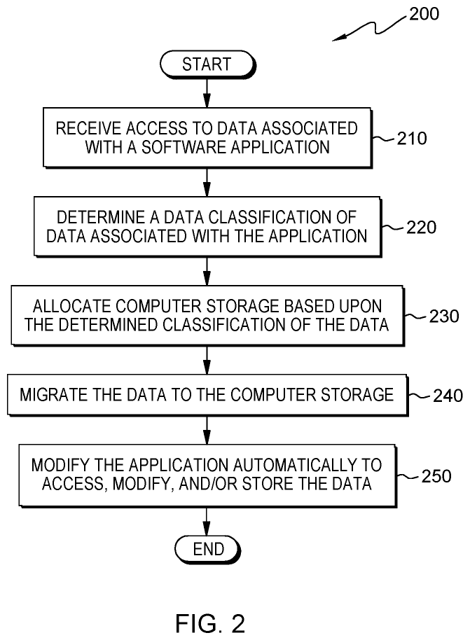

To provide additional details for an improved understanding of selected embodiments of the presently disclosed invention, reference is now made to FIG. 2, which illustrates a flowchart 200 of dynamic management of data storage by data orchestration module 130. Referring to FIG. 2, at step 210, data orchestration module 130 receives access to data (and metadata) generated, created, or made available by data source 120 (or, in alternative embodiments, data and metadata generated directly by software application 110). At step 220, data orchestration module 130 determines a data classification of data associated with the software application 110. As discussed herein, the data classification, in various embodiments, may occur via a review of metadata associated with data, or by others means. In various embodiments of the invention as discussed herein, software application 110 (or some functionality of software application 110) is integrated with data orchestration module 130. All embodiments are contemplated herein. At step 220, data orchestration module 130 allocates computer storage (such as data platforms 170, 180, 190) to store the data pursuant to regulatory/compliance/functional requirements. Data platforms 170, 180, 190 store the data and accordingly limit access to the data stored. At step 230, computer storage in data platforms 170, 180, 190 is allocated to comply with various requirements (or, if based on a changing need for functional/compliance/regulatory data, re-allocated). At step 240, data orchestration module 130 moves, or requests movement of the data to data platforms 170, 180, 190 for further utilization by software application 110. At step 250, (in an embodiment of the invention) data orchestration module 130 modifies, or requests modification of the software application 110 to access, modify, and/or store the data in data platforms 170, 180, 190, without the needs for an application administrator, developer, or another individual to modify the software application 110 by hand. In various embodiments of the invention, this modification may be invisible to source code in software application 110 itself, such as by merely changing a pointer, link, object, class, or invisible method or other source code software application 110.

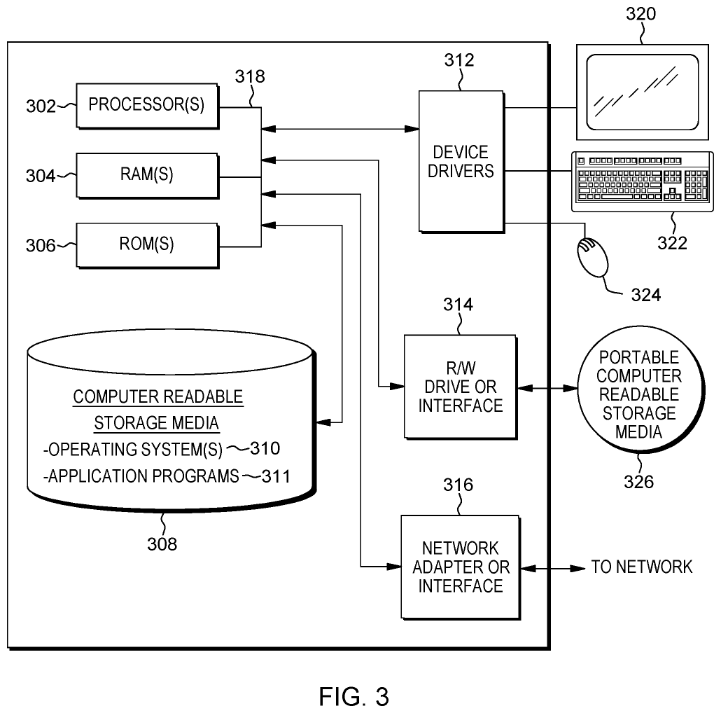

FIG. 3 depicts a block diagram of components of software application 110, data source 120, data orchestration module 130, and data platforms 170, 180, 190 of the environment 100, in accordance with an embodiment of the present invention. It should be appreciated that FIG. 3 provides only an illustration of one implementation and does not imply any limitations with regard to the environments in which different embodiments may be implemented. Many modifications to the depicted environment may be made.

Software application 110, data source 120, data orchestration module 130, and data platforms 170, 180, 190 may include one or more processors 902, one or more computer-readable RAMs 904, one or more computer-readable ROMs 906, one or more computer readable storage media 908, device drivers 912, read/write drive or interface 914, network adapter or interface 916, all interconnected over a communications fabric 918. Communications fabric 918 may be implemented with any architecture designed for passing data and/or control information between processors (such as microprocessors, communications and network processors, etc.), system memory, peripheral devices, and any other hardware components within a system.

One or more operating systems 910, and one or more application programs 911, for example, the environment for provisioner optimization in provision of cloud applications instances 100, are stored on one or more of the computer readable storage media 908 for execution by one or more of the processors 902 via one or more of the respective RAMs 904 (which typically include cache memory). In the illustrated embodiment, each of the computer readable storage media 908 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Software application 110, data source 120, data orchestration module 130, and data platforms 170, 180, 190 may also include a RAY drive or interface 914 to read from and write to one or more portable computer readable storage media 926. Application programs 911 may be stored on one or more of the portable computer readable storage media 926, read via the respective R/W drive or interface 914 and loaded into the respective computer readable storage media 908.

Software application 110, data source 120, data orchestration module 130, and data platforms 170, 180, 190 may also include a network adapter or interface 916, such as a TCP/IP adapter card or wireless communication adapter (such as a 4G wireless communication adapter using OFDMA technology). Application programs 911 on software application 110, data source 120, data orchestration module 130, and data platforms 170, 180, 190 may be downloaded to the computing device from an external computer or external storage device via a network (for example, the Internet, a local area network or other wide area network or wireless network) and network adapter or interface 916. From the network adapter or interface 916, the programs may be loaded onto computer readable storage media 908. The network may comprise copper wires, optical fibers, wireless transmission, routers, firewalls, switches, gateway computers and/or edge servers.

Software application 110, data source 120, data orchestration module 130, and data platforms 170, 180, 190 may also include a display screen 920, a keyboard or keypad 922, and a computer mouse or touchpad 924. Device drivers 912 interface to display screen 920 for imaging, to keyboard or keypad 922, to computer mouse or touchpad 924, and/or to display screen 920 for pressure sensing of alphanumeric character entry and user selections. The device drivers 912, R/W drive or interface 914 and network adapter or interface 916 may comprise hardware and software (stored on computer readable storage media 908 and/or ROM 906).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a method, computer program product, and/or computer system at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, computer program products, and apparatus (systems) according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of method, system, and computer program product according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer program instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

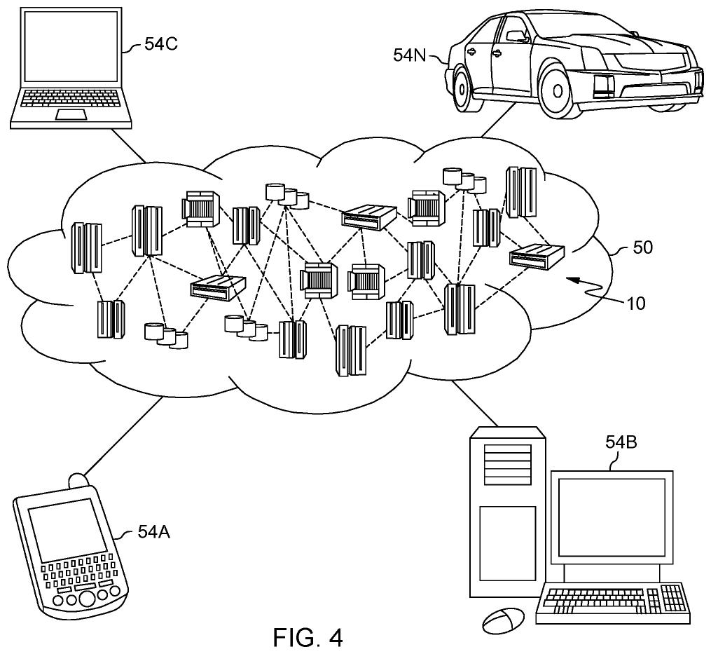

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

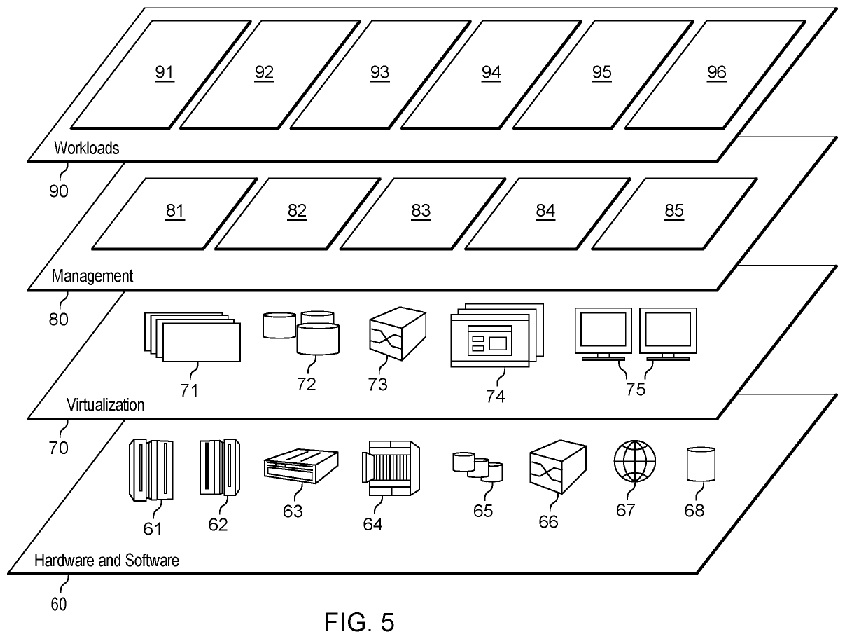

Referring now to FIG. 5 a set of functional abstraction layers provided by cloud computing environment 50 (FIG. 5) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; and transaction processing 95.

Based on the foregoing, a method, system, and computer program product have been disclosed. However, numerous modifications and substitutions can be made without deviating from the scope of the present invention. Therefore, the present invention has been disclosed by way of example and not limitation.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalents.

1. A computer-implemented method for dynamic migration of data associated with an application in response to at least one change in one or more requirements for protection of the data, said method comprising:
dynamically migrating the data from a data source to a new data platform, said dynamically migrating the data comprising:
automatically determining, by a computing device, a data classification of the data associated with the application; and
in response to the at least one change in the one or more requirements for protection of the data, (i) automatically instantiating, by the computing device, a new data platform sufficient to comply with the at least one change in the one or more requirements, (ii) automatically allocating, by the computing device, computer storage in the new data platform based upon the data classification of the data associated with the application, and (iii) automatically migrating the data from the data source to the new data platform in accordance with said allocating.

2. The computer-implemented method of claim 1, wherein allocating by the computing device computer storage further comprises deallocating of a previously used data platform and moving or requesting movement of the data to the new data platform.

3. The computer-implemented method of claim 1, further comprising modifying or requesting modification of the application automatically to access, modify, and/or store the data associated with the application in the new data platform.

4. The computer-implemented method of claim 1, wherein the one or more requirements are selected from the group consisting of one or more regulatory requirements, one or more compliance requirements, one or more functional requirements, and combinations thereof.

5. (canceled)

6. The computer-implemented method of claim 1, further comprising accessing by the computing device metadata associated with the data when determining the data classification of the data associated with the application.

7. The computer-implemented method of claim 1, further comprising adding by the computing device new metadata associated with the data classification to the data after the data classification is determined.

8-9. (canceled)

10. The computer-implemented method of claim 1, wherein allocating by the computing device computer storage occurs during run-time of the application.

11. The computer-implemented method of claim 1, wherein the application is a distributed computer application executing in a cloud environment.

12. A computer system for dynamic migration of data associated with an application in response to at least one change in one or more requirements for protection of the data, said computer system comprising: one or more computer processors; one or more computer-readable storage media; program instructions stored on the computer-readable storage media for execution by at least one of the one or more processors, said program instructions comprising:
program instructions to dynamically migrate the data from a data source to a new data platform, said program instructions to dynamically migrate the data comprising:
program instructions to automatically determine, by a computing device, a data classification of the data associated with the application; and
program instructions to in response to the at least one change in the one or more requirements for protection of the data, (i) automatically instantiate, by the computing device, a new data platform sufficient to comply with the at least one change in the one or more requirements, (ii) automatically allocate, by the computing device, computer storage in the new data platform based upon the data classification of the data associated with the application, and (iii) automatically migrate the data from the data source to the new data platform in accordance with said allocating.

13. The computer system of claim 12, wherein the program instructions to allocate by the computing device computer storage in a new data platform based upon the data classification of the data associated with the application further comprise program instructions to deallocate a previously used data platform and move or request movement of the data to the new platform.

14. The computer system of claim 12, further comprising program instructions to modify or request modification of the application to access, modify, and/or store the data associated with the application in the new data platform.

15. The computer system of claim 12, wherein the one or more requirements are selected from the group consisting of one or more regulatory requirements, one or more compliance requirements, one or more functional requirements, and combinations thereof.

16. The computer system of claim 12, the application is a distributed computer application executing in a cloud environment.

17. A computer program product, said computer program product comprising: one or more non-transitory computer-readable storage media and program instructions stored on the one or more non-transitory computer-readable storage media, the program instructions, when executed by the computing device, cause the computing device to perform a method for dynamic migration of data associated with an application in response to at least one change in one or more requirements for protection of the data, said method comprising:
dynamically migrating the data from a data source to a new data platform, said dynamically migrating the data comprising:
automatically determining, by a computing device, a data classification of the data associated with the application; and
in response to the at least one change in the one or more requirements for protection of the data, (i) automatically instantiating, by the computing device, a new data platform sufficient to comply with the at least one change in the one or more requirements, (ii) automatically allocating, by the computing device, computer storage in the new data platform based upon the data classification of the data associated with the application, and (iii) automatically migrating the data from the data source to the new data platform in accordance with said allocating.

18. The computer program product of claim 17, wherein allocating by the computing device computer storage further comprises deallocating of a previously used data platform and moving or requesting movement of the data to the new data platform.

19. The computer program product of claim 17, further comprising modifying or requesting modification of the application automatically to access, modify, and/or store the data associated with the application in the new data platform.

20. The computer program product of claim 17, wherein the one or more requirements are selected from the group consisting of one or more regulatory requirements, one or more compliance requirements, one or more functional requirements, and combinations thereof.
